(19) United States
(12) Patent Application Publication
(10) Pub. No.: US 2010/0158441 A1
(43) Pub. Date: Jun. 24, 2010

(54) System And Method For High Speed Dye Doped Polymer Devices

(76) Inventors: Alan R. Mickelson, Boulder, CO (US); Edward M. McKenna, JR., Boulder, CO (US)

Correspondence Address: LATHROP & GAGE LLP, 4845 PEARL EAST CIRCLE, SUITE 201, BOULDER, CO, 80301, US

(21) Appl. No.: 12/705,468

(22) Filed: Feb. 12, 2010

Related U.S. Application Data
(63) Continuation-in-part of application No. 12/188,050, filed on Aug. 7, 2008.
(60) Provisional application No. 60/954,411, filed on Aug. 7, 2007.
(60) Provisional application No. 60/954,377, filed on Aug. 7, 2007.

(51) Int. Cl. G02B 6/34; G02B 6/00; B05D 3/06; B01J 19/10

(52) U.S. Cl. 385/37; 385/122; 427/532; 427/560; 385/145

(57) ABSTRACT

A slow light optical dye doped polymer device for slowing the group velocity of an optical signal. In an embodiment, the slow light dye doped polymer device is a slow group velocity optical/near infrared (NIR) device formed of a substrate supporting a dye doped polymer waveguide layer sandwiched between two optically constraining polymer cladding layers. The waveguide layer includes at least one waveguide which supports Moiré grating slow light structures for slowing the group velocity of an optical signal traveling therein. In another embodiment, the slow light optical polymer device includes the slow group velocity optical portion and a slow phase velocity electrical portion. The slow phase velocity electrical portion is formed of a series cascade of combined inductive and capacitive elements generating an electrical field in a field region for transmitting encoded information between the optical portion and the electrical portion.

### RELATED APPLICATIONS

This application is a continuation in part of U.S. patent application Ser. No. 12/188,050, filed Aug. 7, 2008, which claims priority to U.S. Provisional Application Ser. No. 60/954,411, filed 7 Aug. 2007, and U.S. Provisional Application No. 60/954,377, filed 7 Aug. 2007. Each of the aforementioned applications are incorporated herein by reference.

### BACKGROUND

In the field of electromagnetic communications, the millimeter wave regime offers a broad spectrum of frequencies in which compact antenna arrays can be used to create pencil-like beams of radiation, that is, to form the radiating field emanating from the antenna array into a narrow cone or cylinder, for point to point communication. In this millimeter wave regime, absorptive spectral features allow for the use of spectral bands that do not “leak” significantly from the signal path, whereas broad spectral windows permit the use of electronic steering to selectively broadcast long distances at minimal power. For example, high frequency radars can exhibit exquisite target discrimination. The typical metallic conductor millimeter wave feedlines however, can be problematic. Within metallic conductors, such as copper, tinned copper and aluminum, the short wavelengths within the millimeter regime are subject to severe metal losses over longer lengths. Also, conductor lengths are fixed by necessity, that is, by the distance from a feedline origin and to its destination, rather than optimally selecting the conductor length to be a function of the signals wavelength traveling therein. Furthermore, signal dispersion within such a conductor is severe and becomes more so with increasing frequency. Transmission through optical feed and read-out and optical modulation technology are alternative options, although still subject to metal losses. Also, at the receiving point, optical detection is even more problematic with no clear solution that can be scaled with frequency.

One way of overcoming the difficulties with optical detection (or optical modulation, optical switching, optical buffering, etc.) is to introduce slow light structures into a optical portion of the device. Slow light structures introduced in the optical path slow the group velocity of the optical signal and may be used for increasing interact time of the optical signal with an electrical portion of the detector, reducing the dimensional size of an optical component etc. Prior art technologies include photonic crystals and coupled resonator devices, but these devices have extremely high loss.

### SUMMARY OF THE INVENTION

Disclosed is a slow light dye doped polymer device and associated fabrication method.

In one aspect, the slow light dye doped polymer device is formed of a substrate, two optically constraining cladding layers, an optical waveguide layer fabricated in dye doped polymer and positioned between the two optically constraining cladding layers. At least one optical waveguide is configured within the waveguide layer, the optical waveguide formed with slow light structures for controlling the group velocity of an optical signal traveling therein.

In another aspect, the slow light dye doped polymer device is formed with an optical portion and an electrical portion. The optical portion is formed as a slow light dye doped polymer device which includes a substrate, two optically constraining cladding layers, an optical waveguide layer fabricated in dye doped polymer and positioned between the two optically constraining cladding layers. At least one optical waveguide is configured within the waveguide layer, the optical waveguide formed with slow light structures for controlling the group velocity of an optical signal traveling therein. The electrical portion is formed as a CoPlanar Waveguide (CPW) electrical portion. The CPW electrical portion includes an inductive portion formed as a narrow signal line having a inductive aspect controllable at fabrication, a capacitive portion formed as at least one capacitive branch arm, having a capacitive aspect controllable at fabrication, the capacitive portion connected to the narrow signal line and positioned between the narrow signal line and a ground plane, such that a field region exists between the at least on capacitive branch arm and the ground plane. The field region provides electromagnetic communication between the CPW electrical portion and the optical waveguide. Additionally, the phase velocity of a electrical signal traveling within the CPW is phase velocity controlled, by altering the inductive and capacitive aspects of the CPW structure, to match the group velocity controlled optical signal such that the electromagnetic communication is maximized.

A method for forming a slow light dye doped polymer device, includes the steps of depositing on a substrate two optically constraining cladding layer and a thin polymer film layer. Additionally, the steps of photobleaching the thin polymer film layer to form one or more waveguides and slow light structures are performed, and each photobleaching step is followed by a step of annealing the thin polymer film layer to reduce stresses induced by photobleaching is performed.

In another aspect, a method of writing a Moiré grating into a dye doped polymer waveguide, comprising the steps of photobleaching a first Bragg grating into the dye doped polymer waveguide, the first Bragg grating having which has a first period photobleaching a second Bragg grating into the dye doped polymer waveguide, the second Bragg grating having a second period, and annealing the waveguide to relieve stresses caused by photobleaching.

### BRIEF DESCRIPTION OF THE FIGURES

FIG. 1A shows one exemplary slow light device, in accord with an embodiment.

FIG. 1 shows one exemplary slow wave Coplanar Waveguide (CPW) structure, in accord with an embodiment.

FIG. 2 shows a perspective view of one exemplary Optical Rectification Detector (ORD), in accord with an embodiment.

FIG. 2B shows a cross sectional view of the ORD of FIG. 2A, in accord with an embodiment.

FIG. 2C shows an exploded view of the ORD of FIG. 2A, in accord with an embodiment.

FIG. 3 is a graph illustrating a comparison of the calculated frequency response of three ORDs with that of a commercial available detector.

FIG. 4 shows one exemplary setup for bleaching waveguides in PMMA/DR1 and Ultem/DEDR1, in accord with an embodiment.

FIG. 5 is a flowchart illustrating one exemplary method for optical waveguide fabrication, in accord with an embodiment.

FIG. 6 shows one exemplary holographic photobleaching setup for creating Bragg gratings, in accord with an embodiment.

FIG. 7 shows one exemplary setup for photobleaching super period gratings, in accord with an embodiment.

FIG. 8 is a flowchart illustrating one exemplary method for slow light grating fabrication, in accord with an embodiment.

FIG. 9A shows one exemplary interference pattern used to modulate the super period grating in dye-doped polymer waveguide, in accord with an embodiment.

FIG. 9B shows one exemplary dual period grating, in accord with an embodiment.

FIG. 10A shows one exemplary modulator system, in accord with an embodiment.

FIG. 10B shows an exploded view of the modulator of FIG. 10A, in accord with an embodiment.

FIG. 11 shows one exemplary optical buffer, in accord with an embodiment.

FIG. 12 shows one exemplary optical rectification detector, in accord with an embodiment.

FIG. 13 shows one exemplary optical modulator, in accord with an embodiment.

FIG. 14 shows one exemplary optical switch, in accord with an embodiment.

### DETAILED DESCRIPTION OF THE DRAWINGS

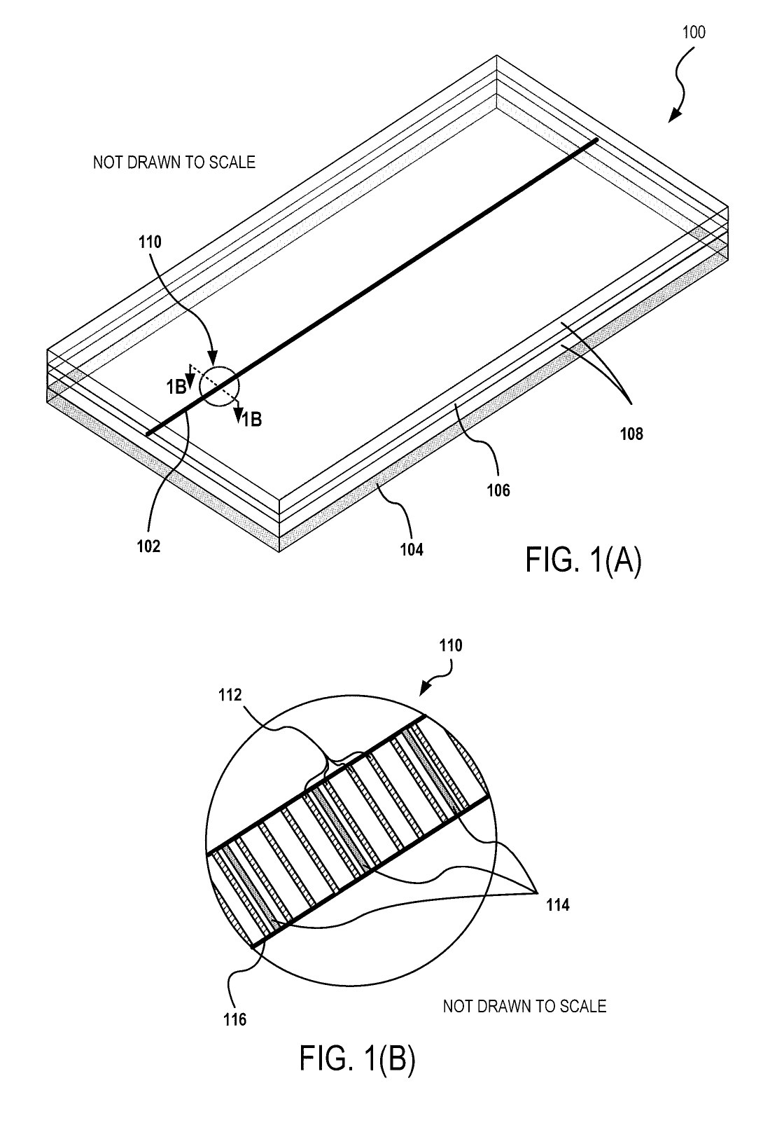

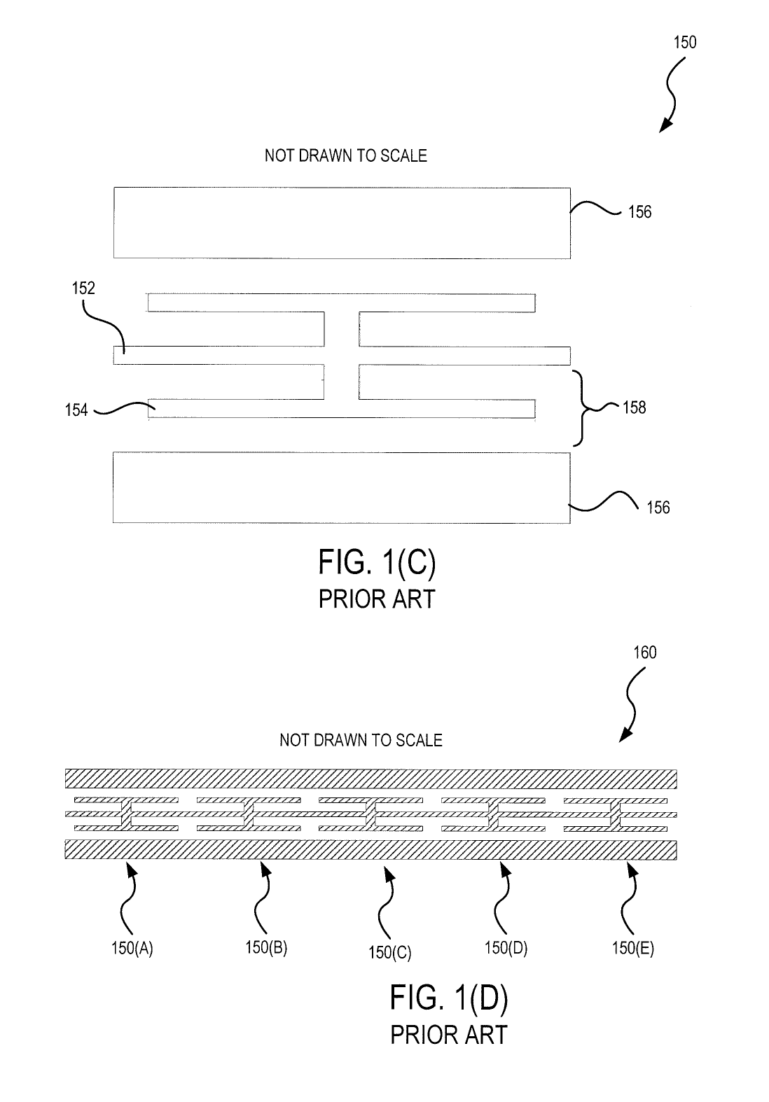

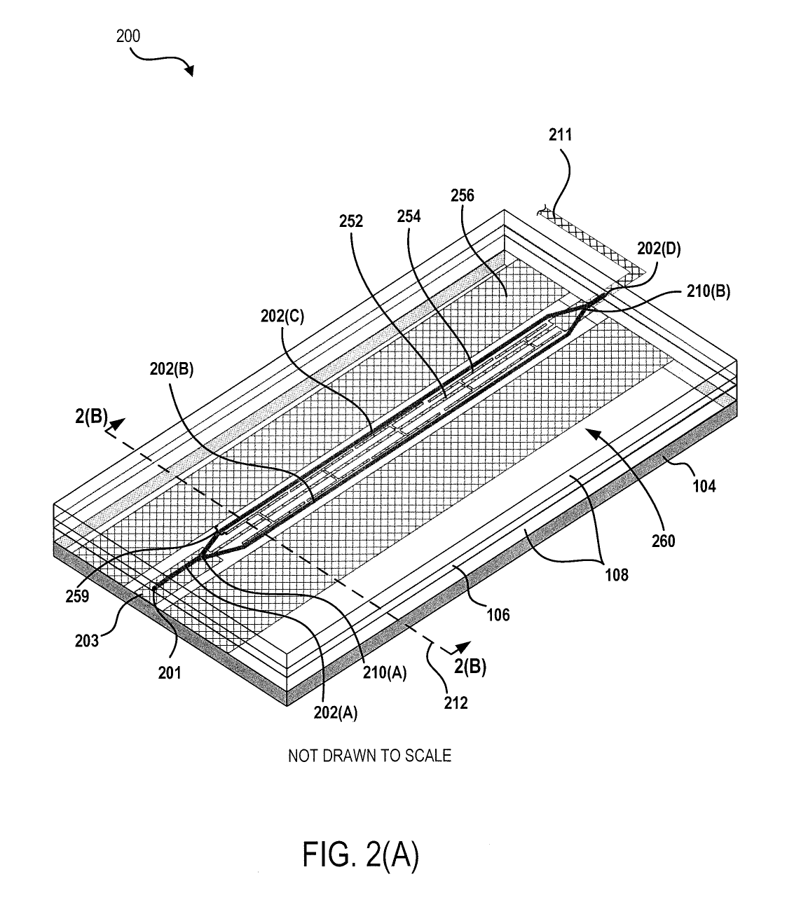

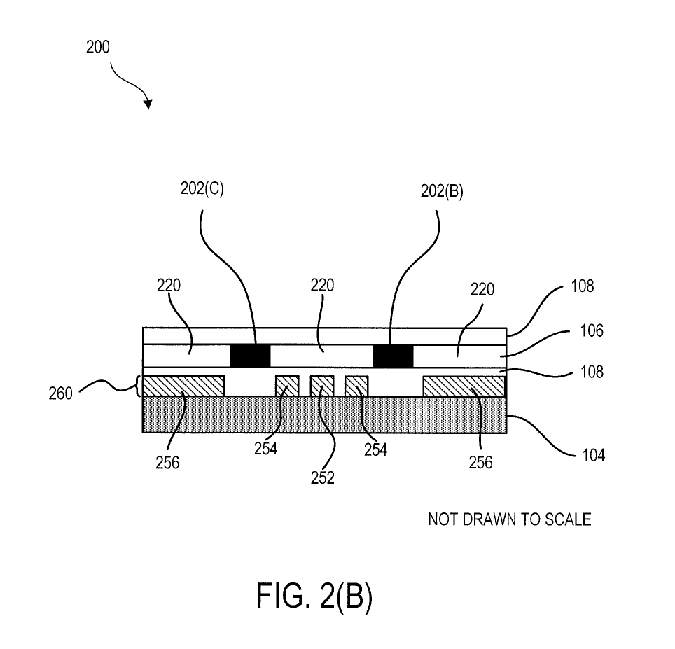

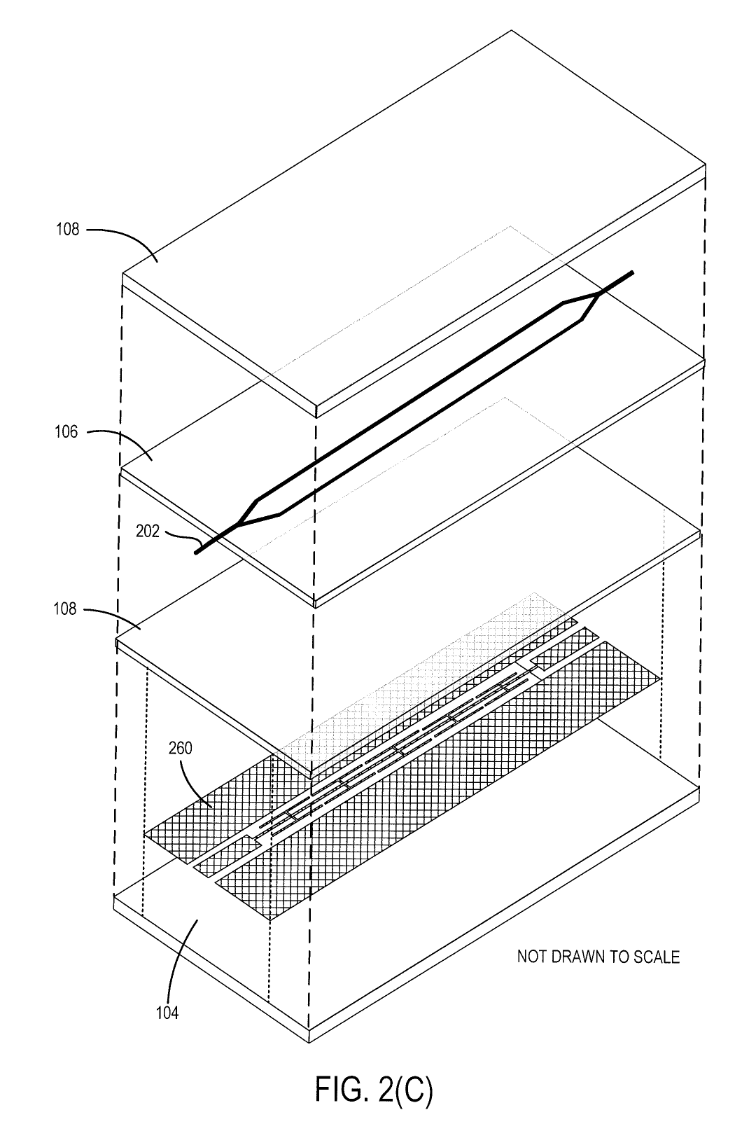

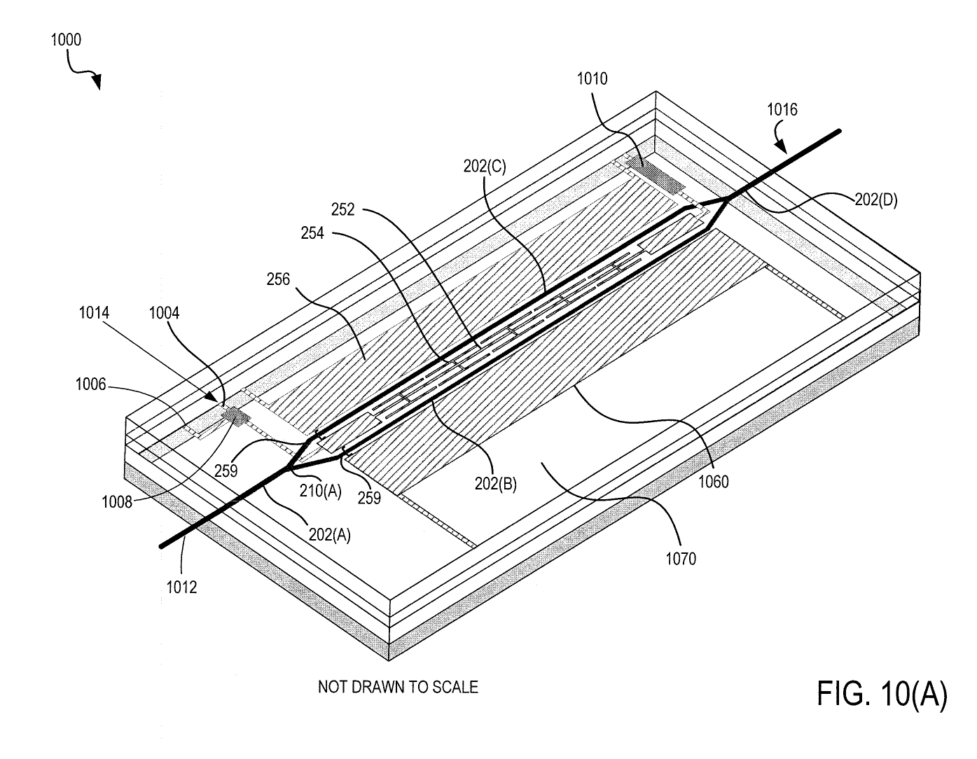

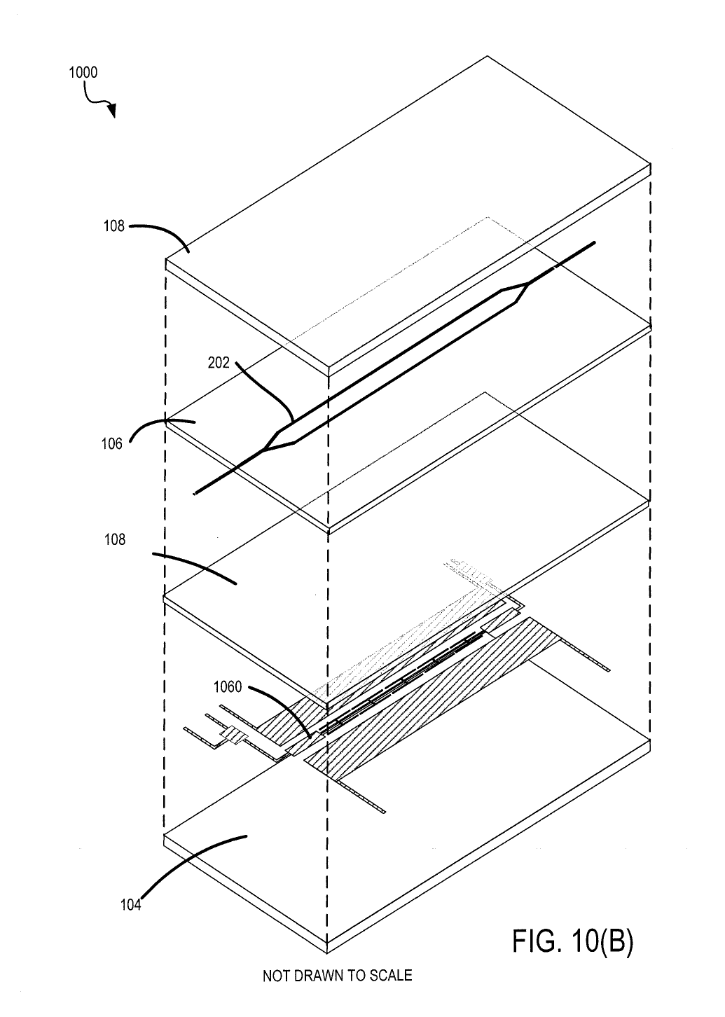

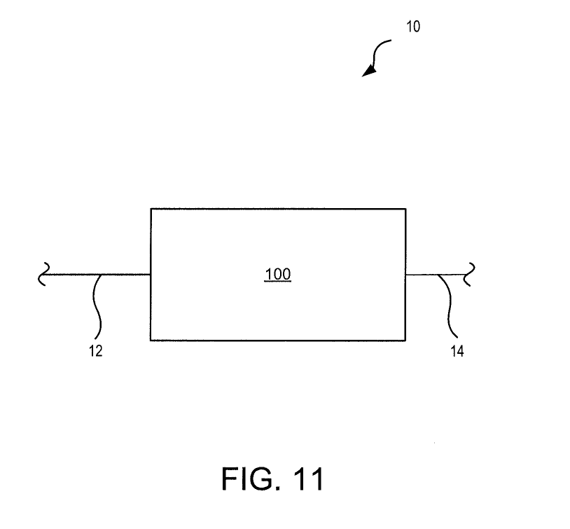

Miniaturized true optical time delay elements (e.g., used in optical buffers and optical storage) are structures, commonly referred to as “Slow light structures,” that reduce the group velocity of light in a medium. These structures may be used in the manufacture of new and improved optical components. Slow light structures (e.g., slow light structures 116 of FIG. 1A) reduce the group velocity of an optical signal to (1) increase the interaction time of the optical signal with nonlinearities in the device's waveguide (e.g., waveguide 102, 202), (2) reduce the scale of an optical devices (e.g., an optical buffer device 100 of FIG. 1, an Optical Rectification Detector (ORD) 200 of FIG. 2, a modulator 1000 of FIG. 10 and an optical switch 1100 of FIG. 11) and (3) enhance existing nonlinearities by increasing signal intensity. Combining an optical waveguide supporting slow light structures with a phase matched electrical component, for example, Miniature low-loss CPW periodic structures (J. Sor, Y. Qian and T. Itoh, Miniature low-loss CPW periodic structures for filter applications, IEEE transaction on Microwave Theory and Techniques 49 (12), 2336-2341 (2001), incorporated herein by reference), shown in FIG. 1B and FIG. 1C, provides an efficient nonlinear integrated optical component (e.g., optical detectors and optical modulators) that may be used over a wide range of frequencies, including the difficult microwave and millimeter wave regimes.

Nonlinear integrated optical devices can be fabricated in dye-doped polymer materials using irreversible photobleaching techniques. Dye-doped polymer materials offer an ideal medium for slow light propagation for a number of reasons. First, dye-doped polymer materials are relatively low loss compared to materials utilized in the prior art (e.g., photonic crystals, coupled resonator devices). Second, nonlinear efficiencies are possible using slow light structures in non-linear dye-doped polymer materials. Third, photobleaching waveguides and slow light structures into dye-doped polymer materials is possible using the novel models and techniques described herein.

The reduction of the group velocity of an optical wave in an electro-optical nonlinear material increases the interaction time of a wave with nonlinearities in the material. If slow light structures are written into a nonlinear medium the nonlinear effects are enhanced due to the increased interaction time of the slowed optical signal with the nonlinearities. For nonlinear dye-doped polymer materials this enhancement has broad applicability, some examples of which are reducing the switching voltage of polymer electro-optic modulators (FIG. 10), generating more efficient optical parametric oscillators (OPO), and enhancing the detection efficiency of polymer ORD's (FIG. 2).

Slow light structures may be formed from submicron structure in nonlinear high glass transition temperature (Tg) dye-doped polymer materials. Dye-doped polymer waveguides materials offer the ideal platform for providing slow light structures, for example, in the form of Moiré gratings. In the dye doped polymer optical devices described herein, a Moiré grating is a dual period alternating index of refraction periodic structure formed within an optical waveguide, an example of which is described in more detail in FIG. 1B. Polymer and dye-doped polymer materials can be spun onto substrates in layers to form the transverse makeup of a device, while device structures, such as waveguides and Moiré gratings, can be written into various layers using the process of irreversible photobleaching to alter the index of refraction of the material. Furthermore, second order nonlinearities can be introduced into the dye-doped polymer devices through the process of poling, for example, by corona poling, a process known in the art. Poling organizes the dye-dope polymer material such that a DC dipole moment is either introduced, or further increased, within the dye doped polymer material to enhance electro-optical properties of the dye-doped polymer material. Enhancing electro-optical properties by poling may increase the efficiency of an optical device in which it is configured. A further benefit to utilizing polymer materials in optical systems, as compared to prior art materials, is the low scattering and absorption losses associated with them, e.g., in the range of 0.1 dB/cm.

A Moiré grating may be generated by (1) holographically writing a first Bragg grating into a dye-doped polymer waveguide and then (2) modulating the amplitude of the index change of the Bragg grating by writing a second periodic structure with a larger period. The second periodic structure may also be written into the waveguide using holographic techniques. The second periodic structure is commonly referred to as having a super-period.

### Photobleaching Model

A new photobleaching model, for example, implemented as computational modules in a computing system, is provided that simplifies the radiative rate equations, an equation well known in the art, by modeling the absorption spectrum of dye-doped polymer materials with Gaussian absorption features. Two of the absorption features that describe states of the dye molecule are dynamically coupled through the radiation field using two parameters. One parameter describes the photobleaching rate and the other describes the coupling between the two absorption features described states.

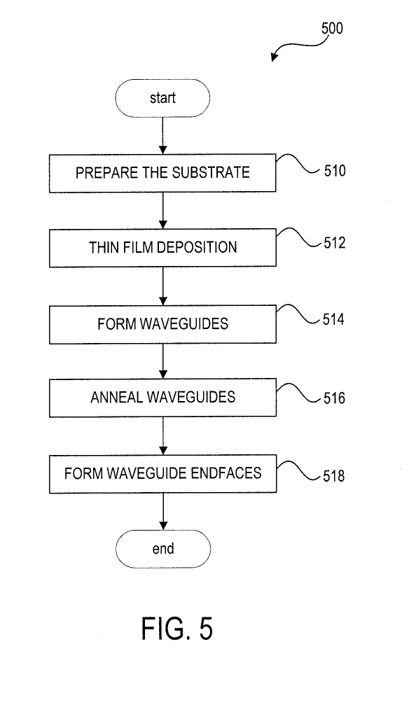

The photobleaching model and associated computational modules may also be expanded to model changes in absorption of the system at the photobleaching wavelength. The model is directly applicable to standard photobleaching setups that don't use other techniques to monitor the absorption spectrum of the film. Moiré gratings are fabricated for the first time in DH6/APC and PMMA/DR1 channel waveguides, but other materials may be used. These gratings are holographically written into the waveguides using irreversible photobleaching and in situ annealing of the film. The annealing of the film is an important and unique part of the process that prevents stresses induced in the material from altering the submicron structure of the gratings, discussed further in FIG. 5.

Moiré Grating

Moiré gratings are Bragg gratings that have their index distribution modulated by a second periodic structure with a period that may be much larger than that of the Bragg grating itself. The index distribution for a Moiré grating may be given by,

$$n ( x ) = {n}_{0} + Δ n * cos ( \frac{2 π}{{Λ}_{s}} x ) cos ( \frac{2 π}{{Λ}_{B}} x ) ,$$

where Δn is the index change, Λ_{S} is the super-period, and Λ_{B} is the Bragg grating period. The Moiré grating reduces the group velocity of the optical wave significantly below that of the optical wave traveling through the medium itself. The ratio of the group velocity of an optical wave in the medium without the slow light structures to the group velocity in the medium with the slow light structures is called the slowing factor (S). It has been shown that the slowing factor for a Moiré grating may be given by,

$$S = \frac{sinh ( π σ )}{π σ} ,$$

where τ is given by,

$$σ = \frac{Δ n {Λ}_{S}}{4 {n}_{0} {Λ}_{B}} .$$

The characteristics of Moiré gratings are determined by the distribution of the index of refraction. In order to control the characteristics of the grating in dye-doped polymers, new models of the irreversible photobleaching process are used. The process of irreversible photobleaching changes the absorption spectrum of the dye-doped polymer materials which is directly related to the change in the index of refraction of the material. These models, for example, may be used to predict the photobleaching process for waveguides for incoherent UV radiation, representing the first time a new set of models and associated computational modules are used to describe the photobleaching process for a coherent source for both guest-host and side-chained polymer systems. The irreversible photobleaching models describe the oscillations in the absorbance spectrum of the dye-doped polymer materials during and after the exposure process. Without the models, the control of the index necessary to form a submicron structures may not be possible.

### Fabrication

Fabrication of structures in dye-doped polymer materials may be performed utilizing semiconductor industry processing techniques such as reactive ion etching (RIE) and electron beam lithography. There are numerous techniques for fabricating optical devices using dye-doped materials. These techniques include RIE, laser writing, poling induced writing, molding/embossing and irreversible photobleaching. While each of these processes maybe used to generate optical devices, irreversible photobleaching is the only process that allows the index of refraction to be controlled. This process is also a natural process to use with dye-doped polymer materials because the dye molecules are readily photobleached. Chemical etching processes such as RIE originated in the semiconductor industry and are inherently problematic for polymer material systems since most polymers may not be chemically resistant enough to withstand the processing. This requires that protective layers of epoxy and metal be adhered to the nonlinear polymer to prevent damage during device fabrication. Thus, these techniques damage polymer films and often require a sacrificial layer to protect nonlinear polymer layers in devices. The process of irreversible photobleaching is ideal for forming Moiré structures, but stresses induced during the process may ruin the film. This problem is solved by including the novel step of an in-situ annealing process, described herein.

FIG. 1A shows one embodiment of an exemplary non-linear slow optical buffer device 100 for reducing the group velocity of an optical signal by means of a slow light structure 116, for example, a Moiré grating, written into waveguide 102. Use of a dye doped polymer material over metallic wave guides reduce losses associated with the metallic wave guides. Polymer materials can have scattering and absorption losses as low as 0.1 dB/cm.

In one embodiment, device 100 may be utilized as an optical buffer, with delay times controlled by (1) the slowing factor associated with slow light structure 116 and (2) the length of device 100.

In another embodiment, an optical storage device it created by tuning the slow light material of device 100 to be close to an instability such that a small change in the index of refraction within waveguide 102 is sufficient to achieve zero group velocity, i.e. indefinite storage. Mathematically, the refractive index distribution of the Moiré grating (described above) can be express in the form n(x)=n₀+a cos(K₁x)+b cos(K₂x), where K₁=2πΛ₁ and K₂=2πΛ₂. When (K₁−K₂)/(K₁+K₂) is much less than 1, an instability arises in the response of the grating to incident light. Small variations in a or b, for example by applying an electric field, can cause the separate reflection peaks from these two periodicities to coalesce to one larger refection peak. Properties of the Moiré grating can be selected such that the slow light wavelength regime is the wavelength regime between these peaks. Coalescing the peaks, for example, by electro-optically tuning a and b, traps any optical signal within the structure (i.e. between the peaks) that is confined to a spatial packet within the structure at the time of the coalescence, that is to say stored within the grating device. If the coalescence causing electrical field applied to the medium is removed, the optical signal exits the optical storage device.

Reducing the group velocity of an optical signal has the added benefit of effectively increasing the length of the wave guide 102, thereby allowing the scale of device 100 to be reduced. In one example, a device with a slowing factor of S=4 is half the length of a device with a slowing factor of S=2 for the same time delay.

Device 100 has a dye doped polymer waveguide layer 106 sandwiched between two un-doped polymer cladding layers 108, all of which adhere to a substrate 104. In one example of fabricating, polymer materials are spun onto substrate 104 in layers to form the transverse makeup of device 100. A waveguide 102 is written into dye doped polymer layer 106 by writing waveguide 102 into waveguide layer 106 using a photobleaching process. Photobleaching alters the index of refraction of the dye doped polymer material such that an optical signal is confined to waveguide 102. In one example of photobleaching waveguide 102 in waveguide layer 106, the dye doped polymer of waveguide 106 is illuminated with light, for example, produced by an argon ion laser tuned to the 514 nm wavelength, which is absorbed the cis and trans isomer states of the dye included in the dye doped polymer.

It should be obvious to one skilled in the art that, in a separate embodiment of the non-linear slow optical buffer device, substrate 104 and air may act as the optically constraining layers, such that cladding layers 108 are not included. In one example of this embodiment waveguide layer 106 is adhered to substrate 104, for example by spinning a dye doped polymer solution onto substrate 104 to form wave guide layer 106. One or more wave guides supporting slow light structures, similar to waveguide 102 supporting slow light structure 116, are then photobleached into the waveguide layer.

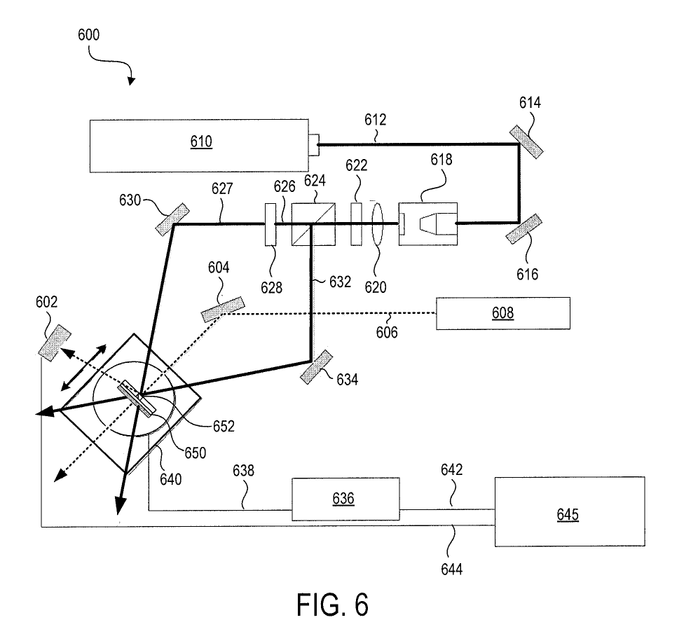

FIG. 1B shows a close-up of waveguide 102 in window 110 of FIG. 1A. Window 110 (FIG. 1B) shows a detailed view of slow light structure 116 in waveguide 102. Slow light structure 116 includes a grating 112 having a first period combined with a grating 114 having a second period, or super period. Slow light structure 116 slows the group velocity of light, i.e. an optical signal, traveling within wave guide 102. In the present embodiment, slow light structure 116 is a dual period altered index of refraction grating structure formed as a Moiré grating. In one example of fabrication, a laser interference patterns writes a Moiré grating is into waveguide 102. In this example, writing a Moiré grating is done by writing a first periodic structure (e.g., a first Bragg grating) into a dye-doped polymer waveguide utilizing a first interference pattern, then modulating the amplitude of the index change of the first interference pattern to produce the second interference pattern which writes a second periodic structure (e.g., a second Bragg grating). The second periodic structure may have a much larger period than the first. The Moiré grating fabrication technique is explained in further detail in FIGS. 6-8.

### Materials

Quartz or glass may used as substrate 104, although other materials (e.g., semiconductors such as silicon, gallium arsenide, indium phosphide, etc.) may be used without departing from the scope herein. Possible non-linear polymer materials used in layer 106 and layers 108 include polymethylmethacrylate (PMMA), amorphous polycarbonate (APC) and polyetherimide (Ultem). Other polymer materials may be used without departing form the scope herein. These un-doped polymer materials beneficially exhibit high glass transition temperatures (T_{g}) of 106 C, 143 C and 160 C respectively. As T_{g} increase the durability required for poling a dye-doped polymer material increases. Poling a dye-doped polymer increases the ElectroOptical (EO) coefficient of the material, the benefits of which are detailed below. Additionally, these polymer materials are well suited for use as optical wave guides due to very low optical losses. It has been shown (in the paper “Optoelectronic Packaging and Polymer Waveguides for Multichip Module and Board-Level Optical Interconnect Applications,” by Y. Liu et. al., IEEE Proceedings: 45th Electronic Components and Technology Conference pp. 185-188 (1995), incorporated herein by reference) that PMMA waveguides exhibit a loss of less than 0.1 dB/cm at 0.63μm while ULTEM and APC have losses less than 0.23 dB/cm at 0.85 μm. Lastly, nonlinear optical polymers exhibit a nonlinear dielectric polarization in response to an electro-magnetic field of an optical signal passing therein. These nonlinear effects typically occur at high optical intensities. It is understood that slowing the group velocity of light, for example, by slow light structure 116 within waveguide 102, increases the intensity of an optical signal. A signal intensity increase within waveguide 102 results in an increase in the nonlinear dielectric polarization of the polymer waveguide. The nonlinear dielectric polarization, in combination with the nonlinearities introduced by poling the dyes within waveguide 102, make device 100 extremely nonlinearly reactive to electromagnetic fields introduced by an optical signal propagating within wave guide 102. The benefits of this is discussed in FIG. 2(A).

Three examples are azo dyes, stilbene like dyes and isophorone dyes. An azo dye contains a nitrogen-nitrogen double bond that bridges the molecule. A stilbene like dye contains a carbon-carbon double bond that bridges the molecule. Examples of possible azo dyes include DEDR1 and DR1 dyes. Examples of possible stilbene like dyes include DH-6 and DCM dyes. In the azo and stilbene like dyes both cis and trans isomer states exist. These isomers, and their absorption spectra, play a role in the phenomenological model of reversible and irreversible effects of photobleaching, that is, both the cis and trans isomer states of the dye absorb light during one or more steps in the photobleaching process. The dyes (also called optical dyes and active dyes) may be added to a polymer material by forming a dye-polymer guest-host system, or by attaching the dye as a side chain to the polymer backbone, both processes are well known in the art. As described above, dyes used to dope polymer layer 106 provide additional nonlinearities and absorption features. Highly nonlinear dyes have large hyperpolarizabilities which result in large delocalized electron orbitals, typical of large conjugated molecules. This adds to the dielectric polarization of the polymer material. The additional absorption features of the nonlinear dyes are provided by the cis and trans isomer states of the dye molecule. Isophorone dyes, which do not exhibit trans to cis isomerization, instead exhibit a transition that leads to high electro-optic activity that can be bleached to lower the index of refraction for waveguide processing purposes, for example, to form claddings, make gratings, etc. An example of an isophorone is CLD.

Side chaining a dye to a host allows a larger dye concentration than guest-host systems which typically suffer from sublimation during film curing. Side chaining also increases the glass transition temperature (Tg) of the polymer/dye system. Increasing the glass transition temperature is advantageous because it may increase the lifetime of devices which utilize the EO coefficient formed by poling the medium. Along with the increased device lifetime, the higher glass transition temperature also introduces a steric hindrance which inhibits isomerization reactions. This will be shown to have a significant effect on the photobleaching rate for materials. One example of a side chain material is PMMA doped with DR1.

Forming a guest-host system includes interspersing the dye, for example, possessing a large molecular hyperpolarizability, into the polymer matrix prior to spinning it onto substrate 104. Two examples of guest-host systems are DCM/BCB and DCM/PFCB.

FIG. 1C shows one exemplary prior art unit cell of a periodic slow wave CoPlaner Waveguide (CPW) structure 150 for slowing the phase velocity of an electrical signal (“Miniature low-loss CPW periodic structures for filter applications”, Itoh et al). The phase velocity of an electrical signal is defined as vₚ=1/\sqrt{LC}, where L and C are the inductance and the capacitance per unit length, respectively. Thus, by increasing L and C, the phase velocity decreases. This may be done by introducing additional periodic structures, such as structure 150, into a CPW. Each structure 150 includes a narrow signal line 252, or inductive portion, which may enhance the inductance per unit length of the CPW, and two branched arms 154 located in slots 158.

Using structure 150 offers several beneficial aspects over other CPW structures. First, the ground planes 156 of structure 150 remain unperturbed. In comparison to some examples of other prior art devices which utilize the method for increasing inductance and capacitance in a waveguide by introducing periodic variations along the direction of propagation, such as by drilling holes in the substrate or by etching patterns in a microstrip ground plane. Because the electric fields in a microstrip line are concentrated in its dielectric substrate region, these periodic variations strongly perturb the nature of the microstrip field distributions reducing signal quality. Second, structure 150 is intrinsically impedance matched over a wide range of frequencies, from DC to approximately 9 GHz, having a relatively flat input impedance. The relatively flat input impedance indicates that the ratio of the inductance and capacitance remain relatively constant, such that structure 150 may be formed into a series cascade of CPW structures 150 to form a CPW 160, as is shown if FIG. 1D, or connected directly to a 50Ω CPW line (not shown) without any additional matching required. This differs from MIS-type transmission lines of the prior art, which typically have very low impedance and thus require additional impedance matching. Third, structure 150 offers very simple fabrication that, for example, can be implemented on one side of a dielectric substrate (not shown) using standard etching techniques. Examples of possible substrates include ceramics (glass, fused silica, etc.), polymer (duroid, Plexiglas, etc.), silicates (silicone, BCB), crystalline (quartz, semiconductors (silicon, GaAs, InP, etc.) and numerous other organic and inorganic solids. No additional procedures, such as ion implanting or cross-tie overlays, are required. Moreover, the completely uniplanar geometry of structure 150 eliminates any uncertainty in positioning the signal line 152 in reference to the ground planes 156. This differs from other prior art microstrip periodic structures, where the insertion loss and return loss vary depending upon where the microstrip's top conductor is placed in reference to the microstrip's periodically etched ground plane. Lastly, it is possible to fabricate structure 150 to be 1/10^{th} the size of similarly functioning prior art devices.

In one example, a CPW 160, made up of structures 150(A)-(E), shown in FIG. 1D, is fabricated on a standard 25-mil Duroid substrate having a dielectric constant ∈ᵣ=10.2. In this example, phase information is extracted from an electrical signal traveling in CPW 160 by a network analyzer and unwrapped to obtain the slow-wave factor. In the present embodiment, the slow-wave factor ranges from 3.3 to 4.4 in the frequency range of 0.25 to 9.75 GHz. In comparison to a 50Ω CPW line on the same substrate, the increased inductance and capacitance per structure 150 result in a slow wave enhancement factor that is 1.4-1.8 times higher than the 50Ω CPW line. In this example, the phase velocity above 9.75 GHz increases exponentially, establishing a broad stopband effect that begins when the length of structure 150 equals half the signal wavelength within line 152. The slow-wave factor of structures 150(A)-(E) can be further enlarged by narrowing the width of the inductive branch, line 152, or by bringing the two branched arms 154 closer to the ground planes 156.

FIG. 2A Shows a schematic depiction of an exemplary Optical Rectification Detector (ORD) 200 for uniquely translating a received information carrying optical signal into an information carrying electrical signal which is processible by electrical components, for example, by a central processing unit, a digital to analog converter, or stored in a storage device (e.g. a hard drive). Such a device is well suited for use in an optical computing system or at the receiving end of an optical communication system. Examples of a source for the information carrying optical signal may be a modulator 1000 (FIG. 10) or a tunable intensity modulated light source that generates a data stream, for example a microwave data stream.

In the embodiment of FIG. 2A, ORD 200 is the unique combination of an optical portion and an electrical portion. The optical portion is a multiple waveguide dye doped polymer slow group velocity optical portion. The transverse make up of the optical portion is similar to device 100, which includes a substrate 104 and a waveguide layer 106 sandwiched between two cladding layers 108. The optical portion also includes a waveguide 202. Waveguide 202 includes waveguide 202A, a divergent branch 210A which splits waveguide 202A into waveguides 202B and 202C, and a convergent branch 210B which combines waveguides 202B and 202C into waveguide 202D prior to waveguide 202D exiting ORD 200. Waveguide 202A in optically connected to an optical input 201. Waveguide 202A is split into waveguides 202B and 202C to facilitate the advantageous combination of the optical portion with the electrical portion, described further below. Similar to device 100, portions of ORD 200 may be poled to increase nonlinearities within ORD 200.

The electrical portion is a slow phase velocity series cascade CPW electrical portion, hereafter called Series Cascade Structure (SCS) 260. Similar to CPW 160, Series Cascade Structure (SCS) 260 includes a series cascade of CPW structures 250, which are similar to CPW structures 150. Each CPW structure 250 includes a narrow signal line 252 similar to narrow signal line 152, two branched arms 254 similar to branched arms 154, ground planes 256 similar to ground planes 156 and field regions 259. Field regions 259 include one aspects of the optimizations of SCS 260 of use in ORD 200, which differentiate it over the prior art CPW 160. Other optimizations include the addition of electrical output 211, preparing SCS 260 for good adhesion to substrate 104. Field region 259 is sized for optimal electromagnetic communication of SCS 260 with waveguides 202B and 202C, discussed further below.

Positioning waveguides 202(B) and 202(C) proximate to the field regions 259 of SCS 260 increases the electric field interaction between waveguide 202 and SCS 260. In an embodiment, ORD is formed with a single waveguide positioned proximate to one field region, however the single waveguide ORD operates at a reduced efficiency as compared to ORD 200.

In one example, an information carrying modulated optical signal originating apart from the ORD 200 is input to waveguide 202 at optical input 201. Un-modulated electrical signal is input to SCS 260 at electrical input 203 and outputs a modulated electrical signal, carrying the same information as the modulated optical signal, at electrical output 211.

In the optical portion of ORD 200, branch 210(A) splits the optical signal into waveguides 202(B) and 202(C), which are positioned proximate to field regions 259, thereby doubling the interaction between SCS 260 and waveguides 202B and 202C. Electro-optical (EO) nonlinearities within waveguide 202B and 202C are acted upon by the electromagnetic field of the modulated optical signal such that the EO nonlinearities oscillate synchronously with the modulated optical signal. Waveguides 202(B) and 202(C) are positioned proximate to field regions 259 such that the oscillating EO nonlinearities within waveguide 202B and 202C generate a modulated electromagnetic field around waveguides 202B and 202C, which propagates within field regions 259. This modulated electromagnetic field induces a modulated electrical signal, carrying the same information as the modulated optical signal, within SCS 260. The induced modulated electrical signal exits SCS 260 at electrical output 211.

ORD 200 optimizes transfer of information from the optical portion to the electrical portion by phase matching the slow group velocity optical signal and slow phase velocity electrical signal to increase the transduction efficiency. Slow light structures 116 (e.g. Moiré grating), included in the optical path (e.g., waveguides 202B and 202C), slows the group velocity of the optical signal, similar to FIGS. 1A and 1B. To substantially synchronized (i.e. put in phase) the electrical and optical waveforms, an appropriate number of CPW structures 250 are included in SCS 260. That is, a certain phase velocity slowing factor is associated with each CPW structures 250, as described in FIG. 1B, such that an appropriate number of CPW structures 250 slow the phase velocity of the electrical signal to place it in phase with the optical signal. Synchronizing the electrical waveform and the optical waveform maximizes information transfer from the optical portion to the electrical portion. Slowing the group velocity of the optical signal also (1) increases the time of the optical signal remains with ORD 200 and (2) increases the intensity of the optical signal, both of which increase the interaction between the optical signal and electro-optical nonlinearities within the dye doped polymer waveguides. Furthermore, slowing the group velocity of the optical signal enables ORD 200 to be made dimensionally smaller than prior art detectors.

ORD 200 may be fabricated with SCS 260, similar to CPW 160 of FIG. 1C, positioned on substrate 104. Series cascade structure 260 may be positioned on or in contact with one or both of cladding layers 108 and layer 106, without departing from the scope hereof. However, waveguides 202(B) and 202(C) remain in electromagnetic communication with SCS 260 via electric fields generated in field region 259.

During fabrication of ORD 200, the dye doped polymer matrix within waveguide 202 is poled to introduce second order nonlinearities into ORD 200. Any number of poling techniques may be used, including one or both of corona poling and parallel plate poling, techniques known in the art.

Poling may turn waveguide 202 into an ElectroOptic (EO) medium or enhances the EO properties of the medium. EO mediums are endowed with a DC dipole moment such that the electro-magnetic field of an optical wave propagating through the medium alters the mediums dipole structure and changes the distribution of charge in the medium. This alternating charge distribution generates an alternating electric field in field region 259 which causes an alternating current to flow in SCS 260. This alternating current is an electrical signal which contains the same information encoded in the optical signal. In one example, corona poling is used to pole polymer layer 106. Corona poling places the substrate between a ground plane and one or more corona needles and then a high voltage (e.g., thousands of volts) is applied until a discharge is measured. Other poling techniques, such as parallel plate poling, may be used without departing from the scope hereof.

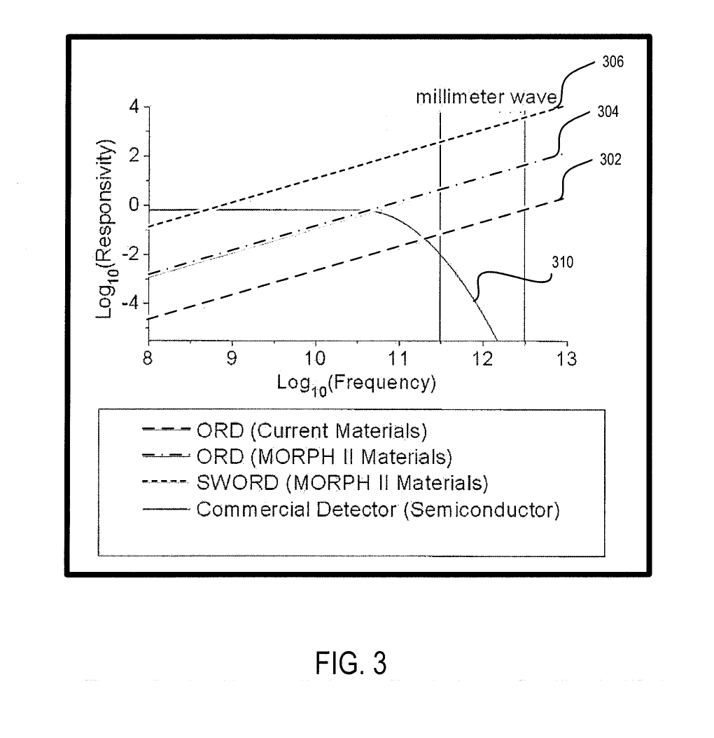

An additional benefit to poling at least a portion of polymer layer 106 is a voltage bias becomes optional. That is, the EO medium of waveguide 202 induce charge motion in SCS 260 by means of the DC dipole moment in the EO medium, as described in FIG. 1A. An optical wave propagating through such a medium alters the dipole structure of the EO medium and changes the distribution of charge within the EO medium. An alternating charge distribution creates an alternating electric field around waveguide 202 which resides in field region 259. The alternating electric field in field region 259 produces an alternating current in SCS 260 in the form of an electrical signal which carries the same information as the field generating optical signal within waveguides 202. With the phase velocity of electrical signal matched to the group velocity of the optical signal (described above), the current of the electrical signal will grow with propagation length. The generated electric field is linearly proportional to the time rate of change of the intensity and the EO coefficient of the EO medium. It is a strong effect in the higher frequency range, for example, stronger in the THz frequency range than the GHz frequency range. One advantages aspect of including slow light structures into a wave guide (e.g., waveguide 102, 202) is slowing the group velocity of light increases the optical intensity which in turn increases the generated electric field. This can be beneficial in lower frequency ranges, for example, the microwave/millimeter wave regime, where this type of electric field generation is weaker than in the higher frequencies. Thus, including slow light structures 116 in ORD 200 (or device 100, modulator 1000 and switch 1100) increase the frequency range of a device in which it is used. As described in FIG. 3 below, ORD 200 is also well suited for higher frequency ranges.

It should be obvious to one skilled in the art that, in a separate embodiment of the Optical Rectification Detector, substrate 104 and air may act as optically constraining layers, such that cladding layers 108 are not included. In one example of this embodiment waveguide layer 106 is adhered to substrate 104, for example by spinning a dye doped polymer solution onto substrate 104 to form wave guide layer 106. One or more wave guides supporting slow light structures, similar to waveguides 202 supporting slow light structure 116, are then photobleached into the waveguide layer.

FIG. 2B shows a cross sectional view through the plane, indicated by line 212, FIG. 2A, showing SCS 260, made up of narrow signal line 252, branched arms 254 and ground plane 256, formed on substrate 104, and a lower cladding layer 108, formed on SCS 260 and substrate 104. FIGS. 2A, 2B and 2C are best viewed together with the following description. FIG. 2C shows an exploded view of ORD 200 of FIGS. 2A and 2B illustrating the distinct layers 104, 260, 106, 108 of ORD 200. Waveguide 202 is photobleached into layer 106, and so is not shown as a separate layer. Layer 106, including waveguides 202(B) and 202(C) and non-optical regions 220, is formed between lower cladding layer 108 and an upper cladding layer 108. Cladding layers 108 and non-optical regions 220 have an index of refraction such that layers 108 and non-optical regions 220 are optically constraining, that is, an optical signal within waveguides is confined. Lower cladding layer 108 forms around SCS 260, as shown in FIG. 2C, during the manufacturing process.

In an alternate embodiment, lower layer 108 is not included such that SCS 260 is positioned on substrate 104 and within layer 106 with waveguides 202 (B) and (C) are positioned between branch arms 254 and ground planes 256. In the present embodiment, substrate 104 additionally functions as a cladding layer.

In yet another embodiment, SCS 260 is positioned above layer 106.

FIG. 3 is a graph illustrating a comparison of the calculated frequency response of ideal ORDs (e.g., ORD 200, FIGS. 2(A)-(C)) with that of a 40 GHz Discovery Semiconductor detector (the widest bandwidth commercial ORD currently available). Optical rectification is a standard technique for generating THz radiation. Due to its responsivity and functional operation in the millimeter and microwave regime, ORD 200 is suitable for use as an optical rectification detector for lower frequencies, as detailed in the description of FIG. 2B.

Trace 302 shows response of ORD 200 fabricated with an electro-optic (r) coefficient equal to that of lithium niobate, a material often used in non-linear optics. Trace 304 shows response of ORD 200 fabricated with an r coefficient (600 pM/V) of a MORPH II material. Trace 306 shows response of a theoretical ORD 200 fabricated with an assumption of an enhancement factor due to either light slowing and an increased r coefficient of later MORPH phases. The most salient feature of traces 302, 304 and 306 is their linearly increasing responsivity (shown on the y-axis) with increasing intensity modulation frequency (x-axis). This linearity ORD 200 well suited for conversion of femtosecond laser pulses to terahertz (THz) carriers. The theoretical linearly increasing response scales with the factor

$${r}_{eff} = \frac{( r ) ( o )}{{s}^{2}} ,$$

where r_{eff} is the effective electro-optic coefficient, r is the actual electro-optic coefficient of the EO medium (e.g., waveguide 202) o is an overlap factor between the optical and electric fields (e.g., in field region 259) and s is a slowing factor based on the slowing of the phase velocity and group velocity of the electrical wave and optical wave. The maximum r of, for example, lithium niobate is 30 pM/V. MORPH phase II materials will have an r of 600 μM/V. A good overlap ratio for the optical portion and the electrical portion of ORD 200 is on the order of 0.6.

Traces 302, 304, 306 are for an ORD made from today's best EO polymers (MORPH phase II material). Trace 304 is for an ORD 200 made from MORPH phase II material and trace 306 is for an ORD 200 made from MORPH phase II material constructed with a slow light structure, such as slow light structure 116, with a slowing factor of 10. A trace for an ORD 200 made from MORPH III materials without slowing would lie between trace 304 and trace 306.

Another salient feature of the ORD 200 is that it may exhibit a conversion efficiency of greater than one electron per photon at higher frequencies of operation. The conversion mechanism is not a quantum conversion but rather a collective conversion much like the conversion of field to current in an antenna. Responsivity of ORD 200 fabricated with MORPH phase II materials may match today's best detectors at a frequency of roughly 40 GHz and may exceed that efficiency at higher modulation rates. By additionally slowing the waves without losing the match of optical wave group velocity with electrical wave phase velocity, the frequency crossover point between the performance of an ORD 200 and today's best detectors occurs below 1 GHz, in the RF regime. With the increased r coefficient of MORPH III materials, even without slowing, occurs at lower frequencies and efficiency increases linearly with increasing frequency.

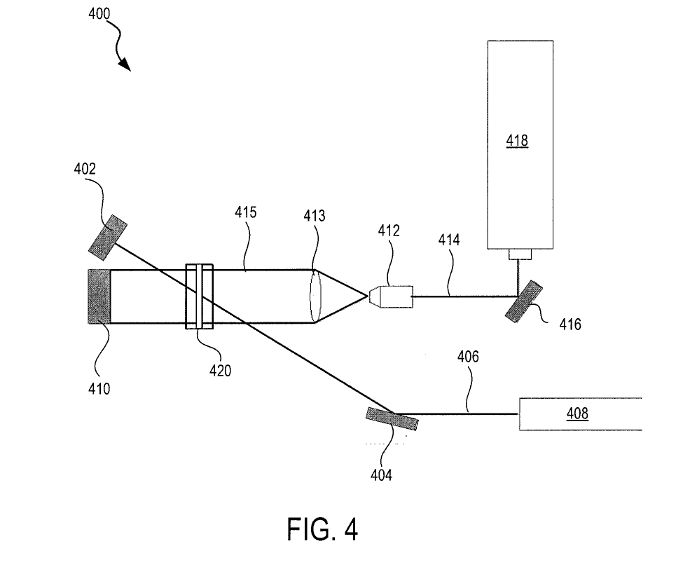

FIG. 4 shows exemplary apparatus 400 for photobleaching waveguides in a layer of a device, for example waveguides 202 in layer 106 of device 420. Device 420 is an optical portion of a device during fabrication, i.e. device 420 may require additional parts to be made functional, for example, upper cladding layer 108. Some examples of device 420 are ORD 200 of FIG. 2 and modulator 1000 of FIG. 10 during fabrication. FIG. 4B shows device 420 in greater detail, which includes substrate 104, cladding layer 108, polymer layer 106 and a photobleaching mask 422. Photobleaching mask 422 includes gaps 424 for passing a bleaching beam 415 there through. A bleaching beam 414 is generated by an argon ion laser 418 and reflected by a mirror 416 through a microscope objective 412 and a lens 413, becoming bleaching beam 415. Bleaching beam 415 partially passes through device 420, shown in more detail in FIG. 4B, and onto a second detector 410. Detector 410 detects bleaching beam 414. A helium neon (HeNe) beam generator 408 generates a HeNe probe beam 406, which is redirected by mirror 404, passes through device 420 and detected by detector 402. Photobleaching mask 422, FIG. 4B, is used in the photobleaching process for forming waveguides in layer 106, a technique known in the art. Device 420 may be in thermal contact with a hot plate to anneal layer 106.

FIG. 5 is a flowchart illustrating one exemplary method 500 for waveguide (e.g., waveguide 102, 202) fabrication using apparatus 400 of FIG. 4A. In step 510, method 500 prepares the substrate. In one example of step 510, glass substrate 104 is made from a pre-cleaned, one inch by three inch microscope slide that is cleaved into two pieces. Substrate 104 is cleaned using a 5-step process. In one example, substrate 104 is placed in an ultrasonic bath in deionized (DI) water with a detergent, for example 3% Liquinox, at 45 degrees Celsius (C) for 10 minutes. Substrate 104 is then rinse with DI water, given an ultrasonic bath in DI water at 45 degrees C. for 10 minute, an ultrasonic bath in methanol at 60 degrees C. for 10 minute and finally given an ultrasonic bath in acetone. The substrate 104 cleaning process may be repeated as necessary to ensure polymer layer 106 has good adhesion to substrate 104 in step 512. After substrate 104 is cleaned, it may be stored temporarily in methanol to prevent any film from forming on substrate 104 due to the evaporation of acetone in air.

In step 512, method 500 deposits at least one thin polymer film layer onto the substrate. In one example of step 512, thin film layers 106 and 108 are generated by spinning a polymer solution onto substrate 104 to form cladding layer 108, then spinning a dye doped polymer solution on cladding layer 108 to form waveguide layer 106. One example of the polymer solution and dye doped polymer solution are PMMA and PMMA/DR1, respectively, both prepared by IBM Almaden Research Center (ARC). PMMA/DR1 comes in a solution in dyglyme with a concentration of 22.5% by weight. In one example of step 512, PMMA solution is spun onto glass substrate 104 at 3000 rpm for 30 seconds to form layer 108 that is approximately 2.5 μm thick. Substrate 104 and layer 108 are prebaked at 90 degrees C. for three hours and then post baked at 120 degrees C. for 17 hours. The spin curve for PMMA and the relationship between film thickness and spin speed can be found in U.S. Provisional Application Ser. No. 60/954,411, incorporated herein by reference.

In step 514, method 500 forms waveguides in one of the polymer film layers, for example, waveguides 202 in layer 106. In one example of step 514, waveguide 202 is photobleached into the polymer layer 106. Waveguide 202 is formed by placing channel waveguide contact mask 422 over the film layer 106 and exposing the film layer 106 with the multiline visible radiation from a Coherent Innova 300 argon ion laser 418 (FIG. 4). In this example, the bleaching intensity is approximately 400 mW/cm². The absorption of the film layer 106 is monitored using beams 415 and 406 having wavelengths of 488 nm and 632.8 nm, respectively. The wavelength of the 488 nm beam is monitored to determine the peak absorption of dye in the film layer 106 and the determined change in peak absorption is used to calculate the approximate index change of the film layer 106. Beam 406, originating at HeNe beam generator 408 (FIG. 4), is monitored to determine the absorption tail and aids in the verification of the relation between the peak absorption and the residual absorption. The bleaching setup is illustrated FIG. 4.

In step 516, method 500 anneals the waveguides on a hotplate to relieve stresses induced during the photobleaching process of step 514. In one example of step 516, the layer 106 is annealed at 110 degrees C. in an oxygen rich environment (to reduce photobleaching time) and may be performed by means of s-polarized radiation since the dipole moment of the dye molecule is ideally oriented along the polarization vector of the incident bleaching field in order for the reaction to occur.

In step 518, method 500 forms the waveguide endfaces. In one example of step 518, after the waveguides 102, 202 are bleached into the film layer 106, the waveguide endfaces are formed by cleaving the substrate 104. One example of the cleaving process is scratching substrate 104 with a diamond scribe and placing the substrate 104 between two plates such that the scratch in the substrate surface is aligned with the edge of the plates. Pressure is then applied to the substrate 104 which cleaves substrate 104 and layer 106 leaving a smooth low loss endface on the waveguide 202. Waveguides 102, 202 may then be tested for loss and mode shape. Alternative methods of forming endfaces may be used without departing from the scope hereof.

To improve adhesion between substrate 104 and polymer layers an adhesion layer may be formed between substrate 104 and polymer layers.

FIG. 6 shows one exemplary holographic photobleaching apparatus 600 for creating Bragg grating 112 in waveguide 652. Waveguide 652 is similar to waveguide 102 prior to fabrication of slow light structure 116. Photobleaching Bragg grating 112 into waveguide 652 is accomplished by exposing waveguide 652 to an appropriately formed photobleaching interference pattern, as generated by apparatus 600.

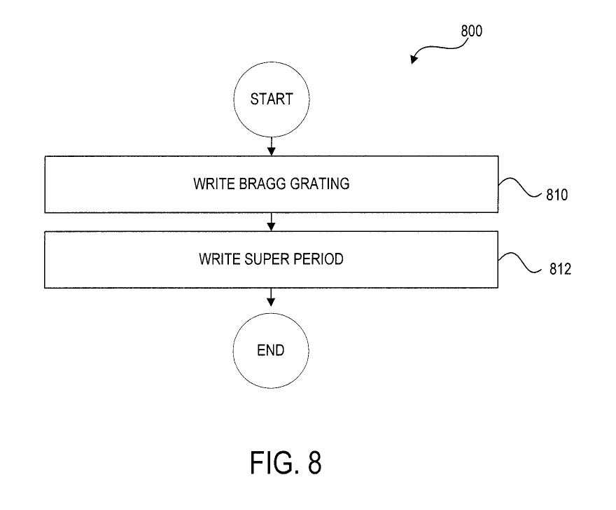

In one embodiment of apparatus 600, a HeNe beam generator 608 generates helium neon (HeNe) probe beam 606 which is redirected by mirror 604 onto the surface of device 650. In one example, the surface of device 650 is the surface of layer 106 after spinning layer 108 onto layer 106. In this example probe beam 606 passes through layer 108 unimpeded. In another example, the surface of device 650 is the surface of layer 106, prior to spinning layer 108 onto layer 106. Device 650 may, for example, be device 100, ORD 200 or modulator 1000 (FIG. 10), during fabrication of a first Bragg grating. Optionally, a phase mask and/or a contact mask may be used in the Bragg grating process performed by apparatus 600. A detector 602 monitors at least a portion of HeNe probe beam 606. An argon ion laser 610 generates a photobleaching beam 612 that is redirected by mirrors 614 and 616 into a spatial filter SF1 618. Beam 612 travels through SF1 618, a lens 620, and a Half Wave Plate (HWP) 622 onto beam splitter 624 where beam 612 is split into beams 626 and 632. Beam 626 travels through HWP 628, forming beam 627, and is redirected by mirror 630 onto device 650. Beam 632 is redirected by mirror 634 onto the device 650. The combination of photobleaching beams 627 and 632 form an appropriate interference pattern to generate the Bragg grating within the waveguide (e.g., waveguide 102 and waveguide 202), discussed in further detail in FIG. 8.

A temperature control device 636 monitors and controls the temperature of a transition/rotation stage 640, and thereby of device 650, which is mounted to transition/rotation stage 640, through a connection 638, heating unit or hot plate (not shown) and a temperature sensor (not shown). Computer 645 may monitor and control temperature control device 636 via connection 642. Also, computer 645 receives absorption tail data, from detector 602 via connection 644, which aids in the verification of a relationship between the peak absorption and the residual absorption.

Device 650 may be positioned on a hot plate (not shown) to for the purpose of annealing waveguides 652 to relieve stresses induced photobleaching laser generated by argon ion laser 610. Computer 645 may be running software for use on the PC Labview program. Other Bragg grating fabrication apparatuses may be used without departing from the scope hereof.

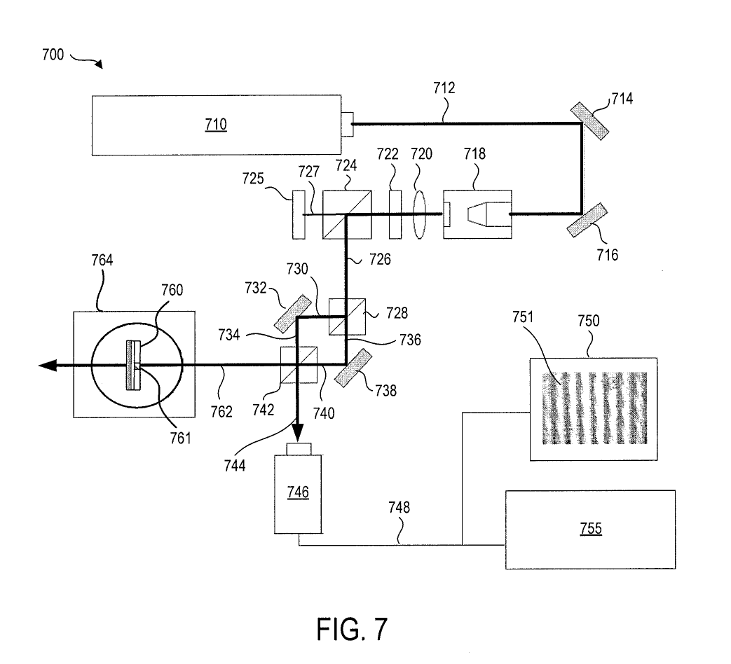

FIG. 7 shows exemplary apparatus 700 for photobleaching grating 114, having a super period, into polymer a waveguide 761 of a device 760. Photobleaching grating 114 into waveguide 761 is accomplished by exposing waveguide 761 to an appropriately formed photobleaching interference pattern.

In the present embodiment an argon ion laser 710 generates a bleaching beam 712 that is redirected by a mirrors 714 and 716 into a SF1 718. Beam 712 travels through a SF1 718, a lens 720, and a HWP 722 into a beam splitter 724 to form beam 726 and transmitted beam 727. Beam slitting 724 reflects a large portion of beam 712, for example 99%, to form beam 726 and transmits a small portion of beam 712 (e.g., 1%) to form beam 727. Detector 725 is a power detector which monitors the power level of beam 712 by measuring the power level of transmitted bean 727. Beam 726 is split by a beam splitter 728 into a beam 730 and a beam 736. Beam 730 is redirected by a mirror 732 onto another a beam splitter 742. Similarly, beam 736 is redirected by a mirror 738 onto a beam splitter 742. Splitter 742 combines incoming beams 734, 740, having a slight spatial separation, and divides them into beams 762 and 744. Beam 762 is directed into waveguide 761 of device 760. Device 760 may, for example, be device 100, ORD 200 or modulator 1000 (FIG. 10), during the fabrication of a grating having a super period. The grating in device 760 is fabricated using the beam 762 which is the combination of two beams 734, 740 with slight spatial separation. The slight special separation of beams 734 and 740 generate the interference pattern used to write the super period into waveguide 102, 202. Beam 744 (which is substantially the same as beam 762) is directed onto a camera 746. Camera 746 may be, for example a Pulnix 545 camera. Camera 746 may be controlled and monitored via a line 748. Monitor 750 may display a captured image 751 by a computer 755.

Other setups may be used without departing from the scope herein. For example, apparatus 400, 600 and 700 may be implemented as one apparatus such that a polymer device (e.g., device 100 of FIG. 1, ORD 200 of FIG. 2 and modulator 1000 of FIG. 10), may be fully processed, for example, by method 500 of FIG. 5 and process 800 of FIG. 8, in one apparatus.

Apparatus 600 of FIG. 6 and apparatus 700 of FIG. 7 are used to create slow light structures in the form of a Moiré grating in a device, for example device 100 (FIG. 1), ORD 200 (FIG. 2), and modulator 1000 (FIG. 10).

FIG. 8 is a flowchart illustrating one exemplary process 800 for the fabrication of a Moiré grating or slow light structure 116 in a polymer waveguide (e.g., waveguide 652 of FIG. 6 and waveguide 761 of FIG. 7), using apparatus 600 and apparatus 700.

In step 810, process 800 holographically writes a first Bragg grating, for example, grating 112 into waveguide 652 of FIG. 6, using irreversible photobleaching. In one example of step 810, apparatus 600 (FIG. 6) uses the 514 nm wavelength of the argon ion laser 610, which is the wavelength with the most power and the wavelength close enough to the absorption peak of both DEDR1 and DR1 for photobleaching the dyes to occur. The period of the grating, A, is related to the half angle, θ, between the beams 627 and beam 632 through the relation,

$$Λ = \frac{{λ}_{bleach}}{2 sin ( θ )} ,$$

where λ_{bleach} is the bleaching wavelength. The half angle between the two beams is related to the Bragg wavelength in the waveguide through the following relation,

$$θ = {sin}^{- 1} ( \frac{{n}_{eff} {λ}_{bleach}}{{λ}_{Bragg}} )$$

where n_{eff} is the effective index of the guide and λ_{Bragg} is the Bragg wavelength in the guide.

In one example, the Bragg grating period in waveguide 652 is tested by first using a substrate 104 with unbleached layer 106, for example, made from PMMA/DR1, and illuminating it with a photobleaching interference pattern for grating 112 for one minute using two low intensity beams 627, 632 with intensities of approximately 50 mW/cm² each. This forms a test surface relief grating (not shown) can be compared to the desired Bragg grating period to confirm proper apparatus 600 configuration. The test surface relief grating can be quickly erased by heating substrate 104 close to the glass transition temperature (Tg) or by illumination with circularly polarized light. The surface relief effect can be measured, for example, with an atomic force microscope (AFM). After the correct surface relief grating is generated, device 650, which includes waveguide 652, grating 112 is irreversibly photobleached into the waveguide 652. If other waveguides exist on the substrate, they may be protected from the photobleaching radiation by a rectangular contact mask, for example, made out of aluminum foil, that is positioned over the polymer layer 106 before photobleaching apparatus 600 begins.

Annealing layer 106 then occurs. In one example of annealing, the temperature of layer 106 is raised from 80 degrees C. to 100 degrees C., for example, by passing current through an indium tin oxide (ITO) coated substrate 104 that waveguide 652 is in thermal contact with. This annealing process is done to relieve stresses induced into the layer 106 during the photobleaching process.

To determine the approximate photobleaching time required to achieve a certain index contrast within a polymer material, novel polymer photobleaching models, for example, for PMMA/DR1 and Ultem/DEDR1, are used. The index contrast formed in process 800 determines the width of a stop-band of the grating 112. This is advantageous in Moiré grating fabrications as a Moiré grating is formed of two Bragg gratings, each having an associated stop-band, such that a narrow passband is formed between the two stop-bands. The first stop-band is create in step 810, the second in step 812.

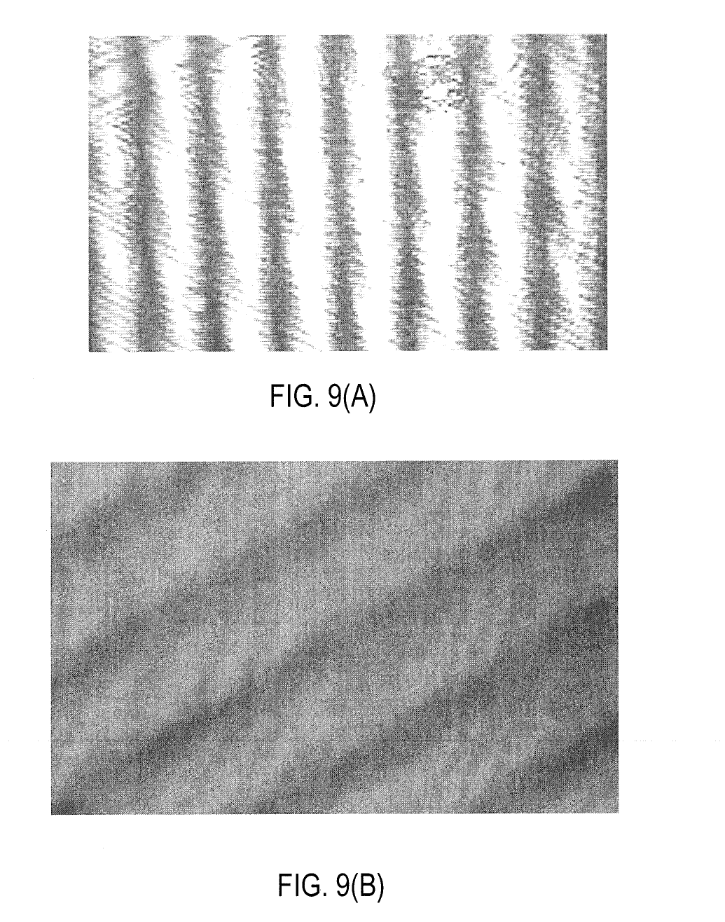

In step 812, process 800, utilizing apparatus 700, photobleaches a second grating (e.g., grating 114) with a super period into the waveguide, thereby forming a Moiré grating. Process 800 then ends. In one example of step 812, process 800 fabricates super period grating 114 using the interference pattern generated by beams 730, 736 with a slight spatial separation. The period of the interference pattern may be visible and may be imaged using a camera, for example, a Pulnix 545 camera. The period of the interference pattern may then be measured using a computer 755, to verify the proper spacing in grating 114. An example of one interference pattern captured by a computer is shown in FIG. 9A.

After the completion of process 800, waveguides (e.g., waveguide 761) may be poled, for example, by corona poling or parallel plate poling.

Mathematically, it can be seen that an index of refraction n(z) of a polymer waveguide material whose index has been modulated as a cascaded Bragg gratings which forms a Moiré grating, e.g., by process 800, and then poled, may be of the form,

n(x)=n₀+Δn cos(Kₛx)cos(K_{g}x),

where n₀ is the index of the unperturbed medium, Δn is the index contrast, in this example Δn is assumed to be the same for both periodicities, Kₛ and K_{g} are the wave numbers of the coherently written gratings which can be defined in terms of their resonant frequencies ω₁ and ω₂ by Kₛ=ω₁/n₀ and K_{g}=cω₂/n₀, where c is the free space speed of light and x is the propagation coordinate.

This index distribution can be expanded using a trigonometric identity to yield,

$$n ( x ) = {n}_{0} + \frac{Δ n}{2} cos ( ( {K}_{g} - {K}_{s} ) x ) + \frac{Δ n}{2} cos ( ( {K}_{g} + {K}_{s} ) x ) ,$$

which has the form of two cascaded Bragg gratings at Kg+Ks and Kg−Ks.

In one example, a 1 cm Moiré gratings with a slowing factor of 2 is formed in a PMMA/DR1 channel waveguide 761. This slowing factor should increase the second order nonlinearity of the poled polymer films of waveguide 761 by a factor of 2.

FIG. 9A shows one exemplary interference pattern used to modulate the super period grating in dye-doped polymer waveguide 761 imaged, for example, using a Pulnix 545 camera.

FIG. 9B shows a differential phase contrast microscope image of one exemplary dual period grating, or Moiré grating, formed in a polymer wave guide (e.g., waveguide 102, 202). In this example, the double grating is designed to slow the group velocity of an optical wave by a factor of five. Other double period gratings and optical group velocity slowing factors are possible.

FIG. 10A shows exemplary modulator 1000 for transfers information of an electrical signal to an optical signal for use in optical communication. Modulator 1000 is similar to ORD 200 (FIG. 2), which includes an electrical portion 1060, similar to SCS 260, and a dye doped polymer based optical portion 1070, although the electrical portion 1060 of modulator 1000 includes additional elements that facilitate optical modulation. Additionally, optical portion 1070 includes an optical output 1016.

Modulator 1000 includes an electrical input 1004, an optional voltage bias input 1006, an optional bias T 1008, and a load matching impedance 1010. Electrical input 1004 receives a modulated electrical input signal. An optional DC voltage is applied to optional voltage bias input 1006, which may be combined with the electrical input at the optional bias-T 1008. Load matching impedance 1010 impedance matches the electrical output of modulator 1000 with a connected device (not shown). DC bias voltage may be applied to voltage bias input 1006 to adjust for fabrication tolerances which may lead to non-zero output signal when the input voltage is zero.

In an embodiment, the electrical portion 1060 receives a data encoded modulated electrical input at input 1004 and a bias voltage at voltage bias input 1006, which are combined at bias-T 1008. A laser diode (not shown) provides optical portion 1070 with an un-modulated optical input at optical input 1012. In electrical portion 1060 of modulator 1000, the modulated electrical signal generates a modulated electromagnetic field in field region 259 that modulates the optical signal within waveguides 202B and 202C. Optical output 1016 outputs a data encoded modulated optical signal.

In the optical portion of modulator 1000, branch 210(A) splits the optical signal into two waveguides 202. Waveguides 202(B) and 202(C) are positioned proximate to field regions 259 such that they are in electromagnetic communication with electrical portion 1060 via the modulated electrical signal generated modulated electromagnetic field. Splitting waveguide 202(A) into waveguides 202(B) and 202(C) doubles the electromagnetic interaction between electrical portion 1060 and waveguides 202. Electro-optical nonlinearities within waveguide 202B and 202 C are acted upon the electromagnetic field within field region 259 such that they oscillate synchronously with the modulated electrical signal. The synchronized oscillation of the electro-optical nonlinearities within waveguide 202 modulate the optical signal therein, producing a modulated optical output which may be used for optical communication.

Similar to ORD 200, modulator 1000 optimizes the transfer of information from the electrical portion 1060 to the optical portion 1070 by phase matching the slow group velocity optical signal and slow phase velocity electrical signal.

The modulated optical signal is then be transmitted, for example, to a distant demodulator (e.g., ORD 200) where the optical signal is transferred into an electrical signal for further processed.

It should be obvious to one skilled in the art that, in a separate embodiment of the modulator, substrate 104 and air may act as optically constraining layers, such that cladding layers 108 are not included. In one example of this embodiment waveguide layer 106 is adhered to substrate 104, for example by spinning a dye doped polymer solution onto substrate 104 to form wave guide layer 106. One or more wave guides supporting slow light structures, similar to waveguides 202 supporting slow light structure 116, are then photobleached into the waveguide layer.

FIG. 10B is an exploded view of modulator 1000 of FIG. 10A. In the present embodiment it can be seen that the electrical portion 1060, which includes SCS 260 and associated electrical components, is positioned below the optical portion, which includes waveguides 202. It is understood that switching the position of the electrical and optical portions of modulator 1000 has little or no effect of functionality and may be done, for example, to ease manufacturing.

FIG. 11 shows one exemplary optical buffering system 10 for providing a time delay in an optical signal. Optical buffering system 10 formed of a buffer 100 having an optical input 12 and an optical output 14. Buffer 100 takes as an optical input signal at optical input 12, and outputs a time delayed optical output signal at optical output 14.

Application of system 10 include, but are not limited to, optical computing, telecommunications, and free-space optical communications, for example, as used in satellite communication.

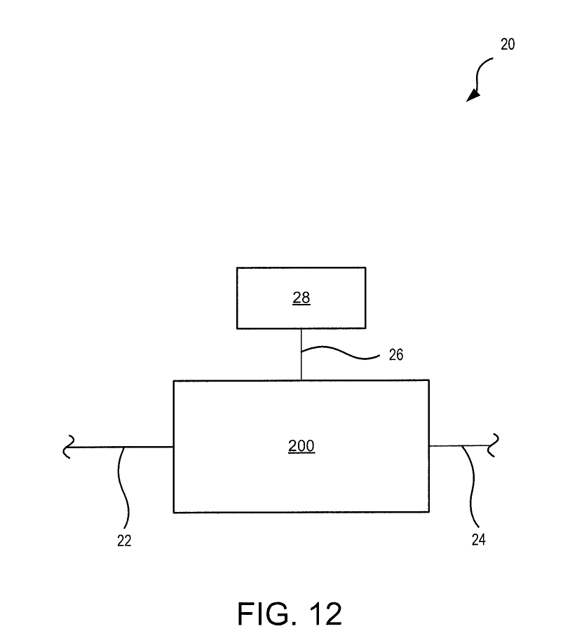

FIG. 12 show one exemplary Optical Rectification Detector (ORD) system 20 for translating an information carrying optical signal into an information carrying electrical signal. ORD system 20 is formed of an ORD 200, optical input 22, optional optical output 24, electrical output 26 and electrical component 28. ORD 200 takes in an information carrying optical signal at optical input 22, translates the information carrying optical signal into an information carrying electrical signal. The information carrying electrical signal, which contains the same information as the information carrying optical signal, is outputted via electrical output 26 to electrical component 28. Optical input 22 may be any medium capable of carrying an optical signal, including, but not limited to an optical fiber, air and a vacuum.

Application of ORD system 20 include, but are not limited to, optical computing, telecommunications, and free-space optical communications, for example, as used in satellite communication.

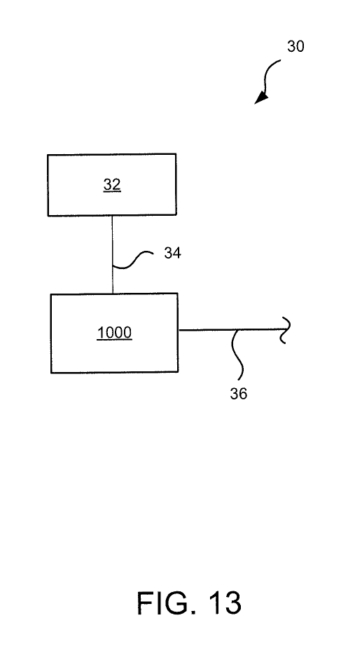

FIG. 13 shows one exemplary optical modulator system 30 for translating an information carrying electrical signal into an information carrying optical signal. Modulator system 30 is formed of modulator 1000, electronic component 32, electrical input 34, optical output 36. Electrical component 32 transmits a electrical signal encoded with data to modulator 1000 via electrical input 34. Modulator 1000 translates the electrical signal into a modulated optical signal. The modulated optical signal is then optically transmitted via optical output 36.

Application of modulator system 30 include, but are not limited to, optical computing, telecommunications, and free-space optical communications, for example, as used in satellite communication.

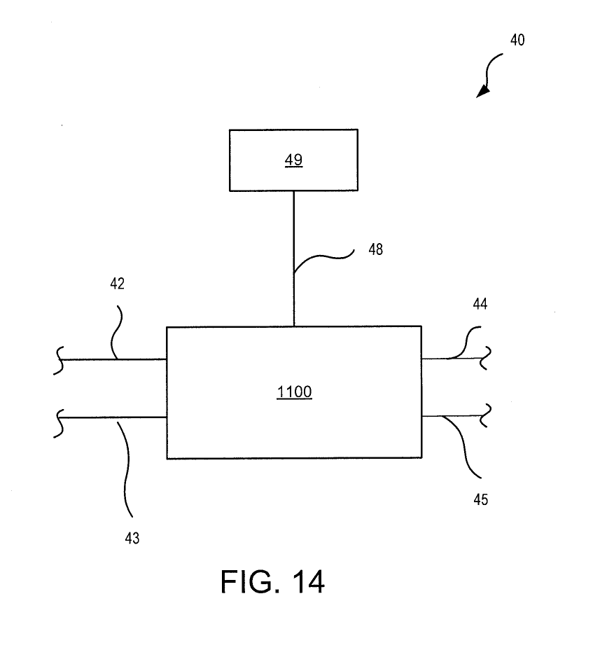

FIG. 14 shows one exemplary switch system 40 for switching optical signals, for example, within a network. Switch system 40 includes an optical switch 1100, optical inputs 42 and 43, optical outputs 46 and 47, electrical input 48 and electrical component 49. One example of switch 1100 is a directional coupler formed, at least in part, in dye doped polymer material, which includes slow light structures, similar to slow light structures 116 of FIG. 1B, in optical wave guides connected to optical inputs 42, 43 and optical outputs 46, 47.

In another embodiment (not shown), an Optical Parametric Oscillator (OPO) is formed in dye doped polymers having the improvement of slow light structures, e.g., slow light structures 116. The two optical signals within a two input OPO must be larger than in a modulator such that the two optical inputs are strong enough to modulate each other in an optical coupling region. The optical coupling region is the region where the two optical channels are spatially separated by a small enough distance such that the strong intensity of the optical signals couple the signals, a process well known in the art. By including slow light structures, similar to slow light structure 116, in an OPO the optical intensity of the optical signal is increased thereby the increasing the coupling of optical signals within the coupling region.

It should be obvious to one skilled in the art after reading the disclosed material herein that the novel aspects provided here may also be applied to other optical and electro-optical devices, including, but not limited to, phase shifters, optical multiplexers, optical demultiplexers, interferometers, optical switch, directional coupler and optical routers.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall there between.

What is claimed is:

1. A slow light dye doped polymer device comprising:
a substrate;
an optical waveguide layer fabricated in dye doped polymer; and
at least one optical waveguide configured within the waveguide layer, and formed with slow light structures.

2. The device of claim 1, the substrate selected from a group consisting of Duroid, quartz, glass, polymer and semiconductor materials.

3. The device of claim 1, further including one or more optically constraining cladding layers.

4. The device of claim 2, wherein the one or more optically constraining cladding layers fabricated from a polymer material.

5. The device of claim 4, wherein the waveguide layer is an annealed layer.

6. The device of claim 4, wherein the waveguide layer is a poled layer.

7. The device of claim 4, wherein the dye is selected from a group consisting of isophorone dyes, azo dyes and stilbene-like dyes.

8. The device of claim 7, wherein the dye is included in the polymer material to form either a guest-host dye-polymer system or a side-chain dye-polymer system.

9. The device of claim 1, wherein the at least one optical waveguide has an index of refraction different from that of the rest of the waveguide layer whereby an optical wave is confined to the at least one waveguide.

10. The device of claim 9, wherein the index of refraction is altered by a process of photobleaching.

11. The device of claim 1, the slow light structures are an periodic, alternating index of refraction structure having a first period and a second period, the second period being greater than the first period.

12. The device of claim 11, wherein the slow light structures are formed by a process of photobleaching.

13. The device of claim 1, the slow light structures are formed as a Moiré grating.

14. The device of claim 13, the optical waveguide are made from material selected from the group consisting of APC/DH6 and PMMA/DR1.

15. The device of claim 13, wherein the index distribution for the Moiré grating is given by the equation
$$n ( x ) = {n}_{0} + Δ n * cos ( \frac{2 π}{{Λ}_{s}} x ) cos ( \frac{2 π}{{Λ}_{B}} x ) ,$$
where n₀ is the unaltered index of refraction of the waveguide, Δn is a change in the index of refraction, Λₛ is a super-period, and Λ_{B} is a Bragg grating period.

16. The device of claim 1, further comprising:
at least one coplanar waveguide (CPW) structure having a field region between a ground plane and an inductive portion and a capacitive portion; and
the at least one CPW structure in electromagnetic communication with the at least one optical waveguide.

17. The device of claim 16, wherein the slow light structures slowing the group velocity of an optical signal traveling therein such the optical signal is a group velocity controlled optical signal.

18. The device of claim 16, wherein the device is a detector having an electrical output carrying a coded electrical signal.

19. The device of claim 16, wherein the CPW structure is a series cascade of CPW structures, whereby the number of CPW structures in the series cascade of CPW structures controls the phase velocity of the signal traveling therein such that the signal is a phase velocity controlled electrical signal.

20. The device of claim 19, wherein the phase velocity controlled electrical signal is matched to the group velocity controlled optical signal whereby electro-magnetic communication originating at the at least one optical waveguide and received by the CPW is substantially optimized.

21. The device of claim 16, wherein an electromagnetic field of the group velocity controlled optical signal interacts with the electromagnetically sensitive nonlinearities within the at least one optical waveguide enhancing the electric field within the field region.

22. The device of claim 16, the at least one optical waveguide comprising:
an optical input;
at least one divergent branch;
at least two post divergent branch waveguides;
a convergent branch; and
at least one post convergent branch waveguide.

23. The device of claim 22, the at least two post divergent branch waveguides positioned proximate to one or more field regions of the CPW structure.

24. The device of claim 16, the CPW structure comprising:
the inductive portion formed as a narrow signal line having a inductive aspect controllable at fabrication;
the capacitive portion formed as at least one capacitive branch arm, having a capacitive aspect controllable at fabrication, connected to the narrow signal line and positioned between the narrow signal line and the ground plane, whereby the field region exists between the at least on capacitive branch arm and the ground plane; and
whereby the phase velocity of a signal traveling within the CPW structure is phase velocity controlled by altering the inductive and capacitive aspects of the CPW structure.

25. The device of claim 24, wherein the phase velocity controlled signal is matched to the group velocity controlled optical signal.

26. The device of claim 24, wherein altering the inductive aspect of the CPW structure includes selecting the width of the narrow signal line during fabrication of the CPW structure.

27. The device of claim 24, wherein altering the capacitive aspect of the CPW structure includes selecting the distance between the capacitive branch arm and the ground plane during fabrication of the CPW structure.

28. The device of claim 16, wherein the device is a modulator, further comprising:
an electrical input for receiving a coded electrical signal to at least one CPW;
wherein the coded electrical signal generates an electromagnetic signal within the at least one field region.

29. The device of claim 28, further comprising:
an bias voltage input;
an bias T; and
a load matching resistance for impedance matching.

30. The device of claim 28, further comprising an unprocessed optical waveguide positioned away from the field region whereby a group velocity controlled optical signal traveling therein is not processed by the coded electrical signal.

31. The device of claim 28, wherein the waveguide layer is processed by poling.

32. A method for forming a slow light dye doped polymer device, comprising the steps of:
depositing thin polymer film layer;
photobleaching the thin polymer film layer to form one or more waveguides; and
annealing the thin polymer film layer to reduce stresses induced by photobleaching.

33. The method of claim 32, further including the step of forming waveguide end faces.

34. The method of claim 32, wherein the step of preparing the substrate includes an ultrasonic bath in deionized (DI) water and a detergent.

35. The method of claim 32, further including the steps of depositing a first cladding layer onto the substrate and wherein depositing the thin polymer film layer is depositing the thin polymer film layer onto the first cladding layer.

36. The method of claim 35, wherein the step of depositing the first cladding layer onto the substrate is spinning a polymer solution onto the substrate.

37. The method of claim 35, further including the step of depositing a second cladding layer onto the thin polymer film layer.

38. The method of claim 37, wherein an adhesion layer is used to secure one or more of the first cladding layer, the second cladding layer and the thin polymer film layer.

39. The method of claim 32, wherein the step of forming one or more waveguides includes photobleaching the thin polymer film layer.

40. The method of claim 39, wherein photobleaching waveguides into the thin polymer film layer includes placing a channel waveguide contact mask over the thin polymer film layer and exposing the thin polymer film layer to radiation from a laser.

41. The method of claim 40, wherein the laser is an argon ion laser.

42. The method of claim 40, wherein absorption of radiation from the laser is determined by monitoring the laser and a probe beam.

43. The method of claim 42, wherein monitoring the laser assists in determining the peak absorption of a dye within the thin polymer film layer.

44. The method of claim 42, wherein the probe beam has a wavelength of approximately 632 nm.

45. The method of claim 44, wherein monitoring the probe beam assists in determining the absorption tail and is utilized in verifying a relation between peak absorption and residual absorption.

46. The method of claim 32, further comprising writing a Moiré grating into one or more of the one or more wave guides to form a slow light structure, comprising:
photobleaching a first Bragg grating having a first period;
photobleaching a second Bragg grating having a second period, the second period being greater than the first period; and
annealing the waveguide to relieve stresses caused by the photobleaching.

47. The method for configuring the slow light polymer device having one or more waveguides with a CoPlaner Waveguide (CPW) such that the CPW is in electromagnetic communication with the one or more waveguides.

48. The method of writing a Moiré grating into a dye doped polymer waveguide, comprising the steps of:
photobleaching a first Bragg grating, having a first period, into the dye doped polymer waveguide;
photobleaching a second Bragg grating, having a second period, into the dye doped polymer waveguide; and
annealing the waveguide to relieve stresses caused by photobleaching.

49. The method of claim 48, wherein photobleaching the first and the second Bragg grating into the dye doped polymer waveguide is done by illuminating the dye doped polymer waveguide with a laser interference pattern generated by two beams with a spatial separation thereby altering the index of refraction of the dye doped polymer waveguide in accord with interference pattern.

50. A modeling device configured with modules for predicting index of refraction change, optical loss and Electro-Optical (EO) co-efficient due to poling.
